(19) United States
(12) Patent Application Publication
(10) Pub. No.: US 2009/0252425 A1
(43) Pub. Date: Oct. 8, 2009

(54) SCALABLE PICTURE ENCODING

(75) Inventors: Wilhelmus Hendrikus Alfonsus Bruls, Eindhoven (NL); Johan Gerald Willem Maria Janssen, Santa Clara, CA (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/721,339

(22) PCT Filed: Dec. 8, 2005
(86) PCT No.: PCT/IB05/54123

§ 371 Date: Jun. 11, 2007

(30) Foreign Application Priority Data
Dec. 13, 2004 (EP) 04106509.5

(51) Int. Cl. G06K 9/36

(52) U.S. Cl. 382/232

(57) ABSTRACT

An encoding device (1) for encoding a picture signal (VS) comprises downsampling means (11) for converting the original picture signal into a downsampled picture signal, first encoding means (14) coupled to the downsampling means (11) for encoding the downsampled picture signal so as to provide a first encoded picture signal (BL), upsampling means (16) coupled to the downsampling means (11) for converting the downsampled picture signal into a upsampled picture signal, subtracting means (13) for producing a residual signal (RS) from the original picture signal and the upsampled picture signal, and second encoding means (14) coupled to the subtracting means (13) for encoding the downsampled picture signal so as to provide a second encoded picture signal (EL). The first encoding means (14) are arranged for lossy coding. The encoding device (1) is arranged for increasing the picture sharpness content of the residual signal (RS), and hence of the second encoded picture signal (EL), for example by using a filter (10).

The present invention relates to scalable image and video encoding. More in particular, the present invention relates to a device and a method of encoding an image or video signal so as to produce at least two encoded signals having different resolutions.

It is well known to encode and decode images (still pictures) and video (moving pictures). A type of picture decoding which is widely used is defined in the international MPEG-2 and MPEG-4 standards, which have been described in, for example, the textbook “H.264 and MPEG-4 Video Compression” by I. E. G. Richardson and G. J. Sullivan, John Wiley and Sons Ltd., 2003. A typical scalable MPEG compatible encoding device comprises:

a downsampler for producing a downsampled picture signal,

a first encoder coupled to the downsampler for encoding the downsampled picture image so as to produce a first encoded picture signal representing a picture having a low resolution (“Base Layer”),

a decoder coupled to the encoder for reconstructing the downsampled picture signal,

an upsampler coupled to the first decoder for reconstructing the original picture signal,

a subtractor for subtracting the reconstructed picture signal from the original picture signal so as to produce a residual (difference) signal, and

a second encoder for encoding the residual signal so as to produce a second encoded picture signal which, together with the low resolution picture, represents a picture having a high resolution (“Enhancement Layer”).

This known encoding technique has the advantage that the decoder may use either the first picture signal, resulting in a low-resolution picture, or both picture signals, resulting in a high-resolution picture. While the first (“Base Layer”) picture signal contains most information, the second (“Enhancement Layer”) picture signal is designed to contain only the additional information necessary to enhance the resolution. However, in practice this second picture signal typically contains artifacts introduced by the (first) encoder and the decoder, which results in an increased bit rate.

The encoding used in MPEG compatible devices is lossy encoding, that is, some information is lost, malting it impossible to fully reconstruct the original input picture signal. This loss of information, which typically occurs in the quantization step involved in the encoding process, causes a degradation of the picture quality. The degradation, which may involve the introduction of artifacts and/or a loss of resolution, is often hardly perceptible while providing the significant advantage of bit rate reduction. However, lossy encoding causes a discrepancy between the original picture signal and the reconstructed picture signal, which in turn increases the information content and hence the bit rate of the second (“Enhancement Layer”) encoded picture signal.

It is an object of the present invention to overcome these and other problems of the Prior Art and to provide a device for and a method of encoding a picture signal which produces a second encoded picture signal having a reduced bit rate while maintaining the lossy encoding and providing an acceptable picture quality.

Accordingly, the present invention provides an encoding device for encoding a picture signal, the device comprising:

downsampling means for converting the original picture signal into a downsampled picture signal,

first encoding means coupled to the downsampling means for encoding the downsampled picture signal so as to provide a first encoded picture signal,

upsampling means coupled to the downsampling means for converting the downsampled picture signal into an upsampled picture signal,

subtracting means for producing a residual picture signal from the original picture signal and the upsampled picture signal,

second encoding means for encoding the residual picture signal so as to provide a second encoded picture signal,

wherein the first encoding means are arranged for lossy encoding, and wherein correction means are provided for increasing the picture sharpness content of the residual picture signal.

By coupling the upsampling means to the downsampling means, the upsampled picture signal has not been encoded and decoded, thus eliminating any artifacts introduced by the encoding and decoding steps. As these artifacts are not included in the residual signal, this signal contains significantly less information and therefore has a strongly reduced bit rate. However, such a residual signal would in many cases lead to a noticeable quality loss. For this reason, the encoding device of the present invention is provided with correction means for increasing the picture sharpness content of the residual signal. Although this increased information content of the residual signal necessarily involves an increased bit rate of the second encoded signal, the resulting bit rate is lower than the bit rate of the corresponding signal of the Prior Art.

It would of course be possible to omit the correction means. However, this would result in picture having a relatively poor image quality. It would also be possible to replace the lossy encoding with loss-less encoding, but that would not necessarily result in a reduced bit rate as the data reduction typically involved in lossy encoding would be sacrificed. In addition, the compatibility with MPEG and other standards, such as AVC, would be lost.

It is noted that European Patent EP 0 577 363 B1 discloses a device for compressing radiological images in which an original image is downsampled, subsequently upsampled and then compared with the original image to produce a difference image. The downsampled image is subjected to differential pulse code modulation, which is a loss-less encoding technique. The problem of avoiding an increase in bit rate caused by a lossy coding technique does therefore not arise in this Prior Art device. In addition, the application of this Prior Art device is limited to radiological images and due to the loss-less coding technique, the device known from EP 0 577 363 B1 is not MPEG compatible.

In the present invention, various correction means for increasing the picture sharpness content of the residual signal can be used. In a first embodiment, the correction means comprise bandwidth reduction means for reducing the bandwidth of the upsampled picture signal. The bandwidth reduction means may be constituted by filter means arranged between the downsampling means and the subtracting means for reducing the bandwidth of the upsampled picture signal. As the upsampled picture signal is subtracted from the original picture signal to yield the residual signal, reducing the bandwidth of the upsampled picture signal increases the bandwidth, and hence the picture sharpness content, of the residual signal while still benefiting from the absence of artifacts.

The filter means are preferably designed in such a way that the frequency distribution of the upsampled picture signal is substantially equal or equivalent to the frequency distribution of the same signal if the first encoding device and the decoding device were arranged between the downsampling means and the upsampling means. In this way, compatibility with existing encoding devices is maintained. Of course the frequency distribution of the upsampled signal may be different, for example narrower, than its counterpart in Prior Art devices, using filter means having a relatively narrow pass-band.

It is noted that conventional encoders and decoders typically contain filters, or at least display filter characteristics, in particular when the encoding involves quantization and/or truncation of the picture signal values. The present inventors have realized that omitting an encoding means and a decoding means from the loop constituted by the downsampling means, the upsampling means and the subtracting means reduces the number of artifacts in the residual signal but also removes the band-limiting filter characteristics of the encoding and decoding means. Accordingly, filter means may be added to accomplish this band-limiting effect without the encoding and decoding means being present.

The filter means may be integral with the upsampling means. That is, upsampling means typically contain a (low-pass) filter, and the characteristics of this filter may be adjusted to provided the desired frequency distribution of the upsampled picture signal. Alternatively, or additionally, the filter means may be arranged in series with the upsampling means. That is, a separate filter unit may be provided, coupled to the upsampling means.

The filter means preferably have a low-pass filter characteristic. That is, lower (spatial) frequencies are passed by the filter means while higher (spatial) frequencies are attenuated.

In the first embodiment discussed above, the correction means comprise filter means arranged between the downsampling means and the subtracting means for reducing the bandwidth of the upsampled picture signal. In a second embodiment, the correction means comprise decoding means and further upsampling means for decoding and upsampling the first encoded picture signal to produce a reconstructed picture signal, further subtracting means for producing the difference of the reconstructed picture signal and the original picture signal and further adding means for adding said difference to the residual signal prior to encoding.

In this second embodiment, two upsampling means are provided for producing two upsampled picture signals, one of which has previously been encoded and subsequently decoded as in the first embodiment, and one of which has not. By subtracting these two upsampled signals from the original picture signal and then combining the resulting residual picture signals, a new residual picture signal is obtained that has an increased information content. That is, the (first) residual picture signal which is produced without encoding and decoding contains no artifacts that may be introduced by the encoding and decoding steps and has a relatively low picture sharpness content. The (second) residual picture signal which is produced using encoding and decoding may contain artifacts and benefits from the filtering effect of the encoding and decoding means, and therefore has a relatively high picture sharpness content. By combining these residual picture signals, the relative contribution of both the artifacts and any unfiltered signal components is reduced, and thus achieving a trade-off which proves very satisfactory. The second encoded picture signal has an information (that is, picture sharpness) content, and hence a bit rate, that is higher than would be achieved without the correction means, resulting in an improved picture quality. Still, the bit rate of the second encoded picture signal is lower than in conventional encoding devices.

It is preferred that the encoding device contains weighting means for weighting the picture signals output by the subtracting means and the further subtracting means respectively. Advantageously, the weighting means comprise multipliers for multiplying the picture signals with a respective factor, the sum of the factors being substantially or approximately equal to one. That is, the weighting means allow the relative contributions of the two residual signal to be determined. It will be understood that, to achieve the benefits of the present invention, both of these two factors should be greater than zero.

In the second embodiment, it may be advantageous to provide additional encoding means for encoding the residual signal output by the subtracting means so as to produce an additional encoded signal. The additional encoding means may be linked with the second encoding means to facilitate the encoding process.

The first and the second embodiment may be suitably combined, thus providing a device of the second embodiment which additionally includes filter means for filtering the upsampled (but not encoded and decoded) picture signal.

The encoding device of the present invention may advantageously further comprise signal analysis means for analyzing the input picture signal and producing a quality signal and multiplication means (or a suitable controlled amplifier) for multiplying the residual signal and the quality signal so as to produce a modified residual picture signal that preferably has an increased amplitude (that is, the quality signal preferably is equal to or greater than one). This allows the residual signal to be attenuated (or amplified) in dependence of the application or the picture signal being encoded.

In a further embodiment, the encoding device of the present invention may further comprise combination means for combining the residual picture signal or the modified residual picture signal and an offset signal so as to produce a mean value corrected residual picture signal. This allows a DC offset to be compensated.

It is particularly preferred if the encoding device of the present invention is arranged for encoding picture images in accordance with an international picture compression standard, preferably an MPEG standard or AVC standard. This ensures compatibility with both existing and future decoding devices. However, the invention is not limited to standard compatibility and may deviate from any standard if required.

In addition, the present invention provides apparatus, such as consumer devices, comprising an encoding device as defined above. By way of non-limiting example, the present invention provides a picture storage device comprising an encoding device as defined above, such as a DVD recorder, a hard disk based picture storage device, a computer running suitable software programs, and equivalent devices.

Another example of the apparatus mentioned above is a network device for transmitting picture information to remote units, the network device comprising an encoding device as defined above. Such a network device may, for example, be used in the home for transmitting pictures to various display screens, computers and other devices.

Yet another example of the apparatus mentioned above is a portable consumer device comprising a receiver, a transmitter and an encoding device as defined above. Such a portable consumer device may be a mobile (cellular) telephone device, or a laptop computer or notebook device having transceiver means.

A further example of the apparatus mentioned above is a camera device comprising an encoding device as defined above. Such a camera device may be a camera for images (still pictures), moving pictures (video), or both.

The present invention also provides a picture-processing device comprising an encoding device as defined above. The present invention additionally provides a decoding device for decoding picture signals encoded with the encoding device defined above, a picture signal encoded by the encoding device defined above or the method defined below, and an information carrier containing picture information encoded by the encoding device defined above or the method defined below. Such a picture signal may be transmitted via any suitable means, for example an electrical cable, an optical fiber cable, or wirelessly, for example using radio waves or infra-red light (infra-red light may be transmitted using Bluetooth® or a similar technology), via cable networks or via the Internet. A suitable information carrier may be constituted by a DVD or similar optical information carrier, or a magnetic information carrier such as a hard disk.

The present invention further provides a method of encoding a picture signal, the method comprising the steps of:

converting the original picture signal into a downsampled picture signal,

encoding the downsampled picture signal so as to provide a first encoded picture signal,

converting the downsampled picture signal into a upsampled picture signal,

producing a residual picture signal from the original picture signal and the upsampled picture signal by subtraction,

encoding the residual picture signal so as to provide a second encoded picture signal,

wherein the step of encoding the downsampled picture signal involves lossy encoding, and wherein the method further comprises the step of increasing the picture sharpness content of the residual picture signal.

The present invention additionally provides a computer program product for carrying out the method as defined above. It is noted that any algorithmic components disclosed in this text may in practice be realized entirely or in part as hardware (e.g. parts of an application specific IC) or as software running on a special purpose digital signal processor or a generic processor. Computer program product should be understood to imply any physical realization of a collection of commands enabling a processor, either generic or special purpose, to execute any of the characteristic functions of an invention after a series of loading steps to load the commands into the processor. In particular, the computer program product may be realized as data on a carrier such as e.g. a disk or tape, data present in a memory, data being transmitted over a (wired or wireless) network connection, or program code on paper. Apart from program code, characteristic data required for the program may also be embodied as a computer program product.

The present invention will further be explained below with reference to exemplary embodiments illustrated in the accompanying drawings, in which:

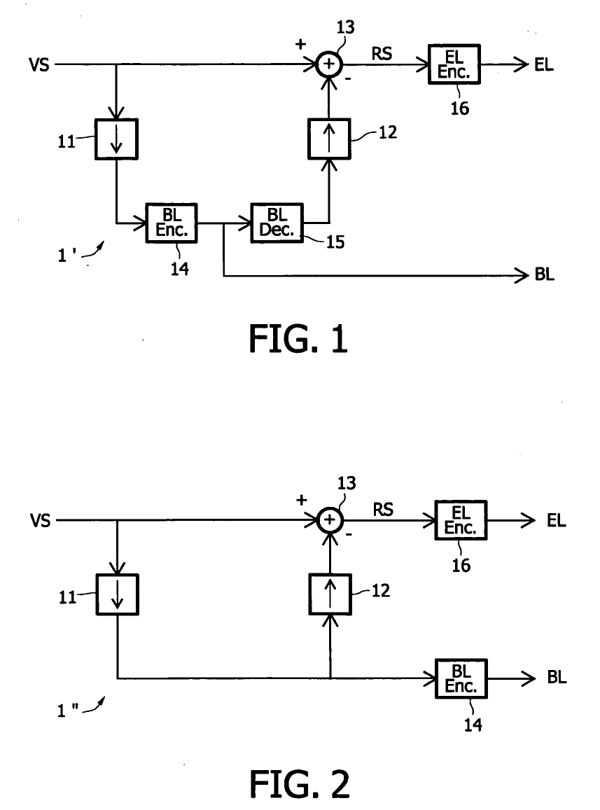

FIG. 1 schematically shows a first picture-encoding device according to the Prior Art.

FIG. 2 schematically shows a second picture-encoding device according to the Prior Art.

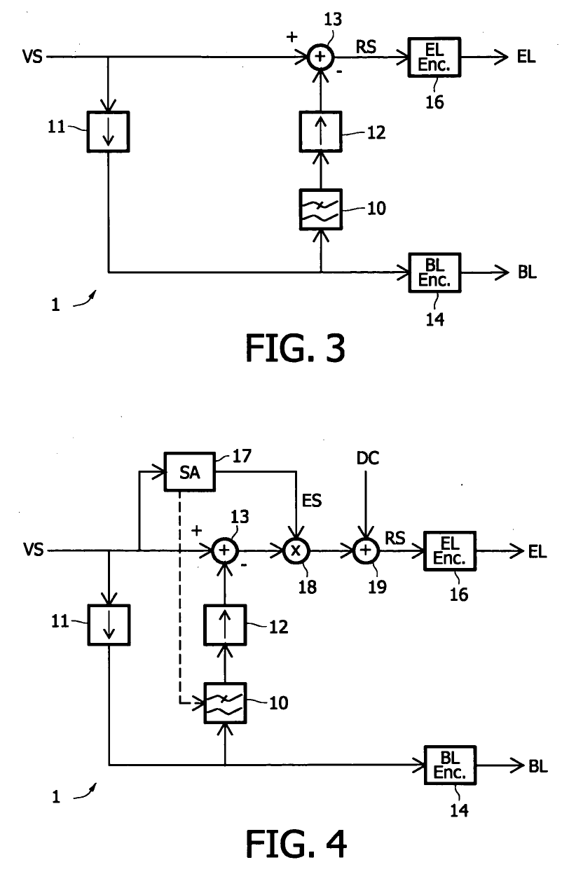

FIG. 3 schematically shows a first embodiment of a picture-encoding device according to the present invention.

FIG. 4 schematically shows a second embodiment of a picture-encoding device according to the present invention.

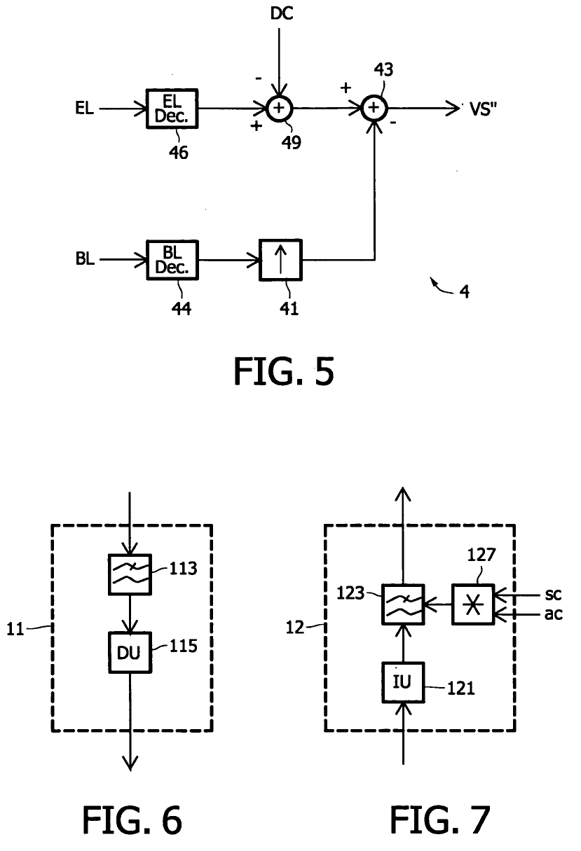

FIG. 5 schematically shows an embodiment of a picture-decoding device in accordance with the present invention.

FIG. 6 schematically shows a first embodiment of a filter unit in accordance with the present invention.

FIG. 7 schematically shows a second embodiment of a filter unit in accordance with the present invention.

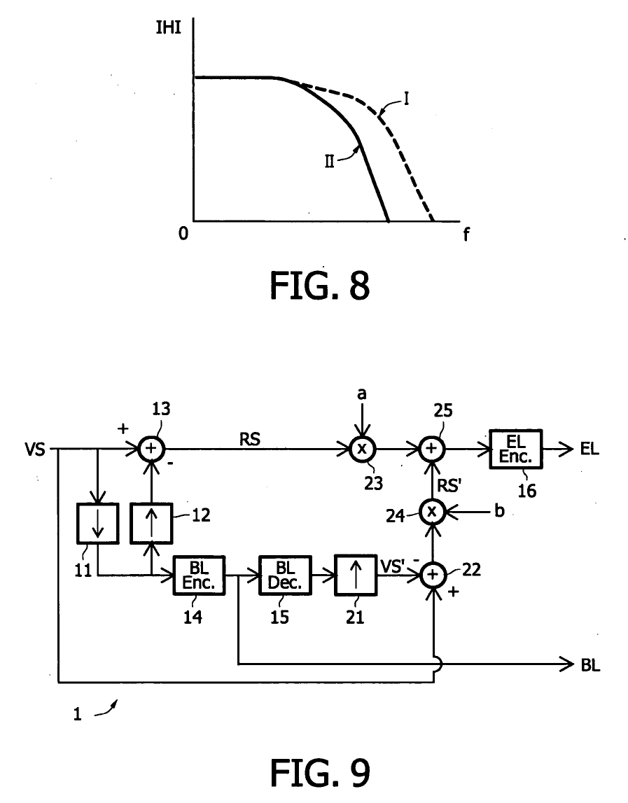

FIG. 8 schematically shows a filter characteristic in accordance with the present invention.

FIG. 9 schematically shows a third embodiment of a picture-encoding device according to the present invention.

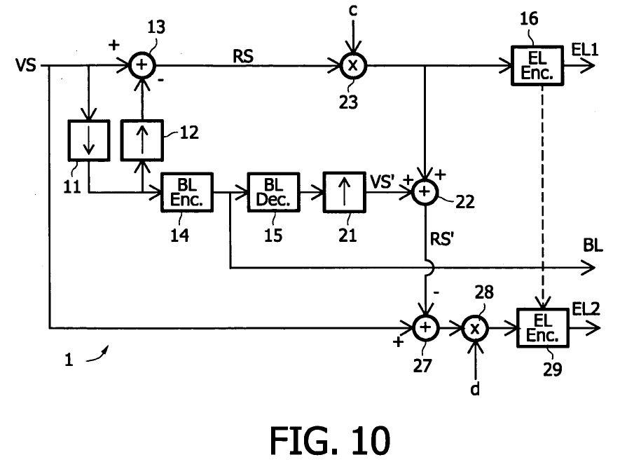

FIG. 10 schematically shows a fourth embodiment of a picture-encoding device according to the present invention.

The Prior Art encoding device 1′ shown in FIG. 1 comprises a downsampler 11, a first encoding unit 14, a decoding unit 15, an upsampler 12, a subtraction unit 13, and a second encoding unit 16. The downsampling unit 11 receives the original picture signal VS and feeds the downsampled picture signal to the first encoder 14 where it is encoded. The resulting first encoded picture signal BL is both output and fed to the decoding unit 15. The decoded picture signal is upsampled in the upsampling unit 12 and then subtracted from the original picture signal VS in the subtraction unit 13. The resulting residual picture signal RS is encoded by the second encoding unit 16 and output as the second encoded picture signal EL. In MPEG compatible systems, the first encoded picture signal BL is called “base layer” while the second encoded picture signal EL is called “enhancement layer”. The first encoded picture signal BL and the second encoded picture signal EL together constitute the encoded picture signal which is transmitted and/or stored.

In this known arrangement, the residual signal RS represents any errors introduced by the downsampling, encoding, decoding and upsampling steps. However, these steps artifacts cause the residual signal RS to contain undesired information, which in turn significantly increases the bit rate (the number of information units per second) of the second encoded picture signal EL. These artifacts are mainly due to the lossy encoding used by the first encoding unit 14, which typically includes quantization and/or truncation of the signal values.

A possible solution is illustrated in FIG. 2, where the encoding device 1″ also has a downsampler 11, an upsampler 12, a first encoding unit 14, a subtraction unit 13 and a second encoding unit 16. However, in the device of FIG. 2, the first encoding device 14 has been arranged outside the loop constituted by the units 11, 12 and 13. In addition, no decoding unit is present. As a result, the residual signal RS contains no artifacts which may be introduced by the first encoder unit 14.

The encoding and decoding units of FIG. 1 not only introduce artifacts but also have a filter function. Such a filter function may be caused by a transform coefficients weighting operation which tends to attenuate higher frequencies. The present inventors have realized that by placing the encoding unit 14 and the decoding unit 15 outside the loop constituted by the units 11, 12 and 13 (FIG. 2), this filter function is lost. As a result, the bandwidth of the upsampled picture signal is widened, the bandwidth of the residual signal RS is narrowed and the picture sharpness content of the second encoded signal EL is reduced. It has been found that this information loss may result in perceptible picture degradation.

This problem is solved by the inventive encoding device 1 illustrated in FIG. 3. The merely exemplary encoding device 1 of FIG. 3 also comprises a comparison loop constituted by a downsampling unit 11, an upsampling unit 12 and a subtracting unit 13, while the first encoder 14 and the second encoder 16 are placed outside this loop. In contrast to the arrangement of FIG. 2, a filter unit 10 is arranged in series with the upsampling unit 12. This filter unit 10 effectively replaces the filter function of the encoding unit 14 and decoding unit 15 which are placed inside the loop in the arrangement of FIG. 1. In this way, the positive effects of placing the encoder unit 14 and decoder unit 15 outside of the loop are retained, while their filter function is replaced by the filter 10.

In FIG. 3 the filter unit 10 is shown upstream of the upsampling unit 12. However, this is not essential and the filter unit 10 may also be placed downstream of the upsampling unit 12. In other embodiments (not shown) the filter unit 10 may be integrated in the upsampling unit 12. That is, an upsampling unit typically includes a filter which may be adapted to have the filter properties of the additional filter 10. This is schematically shown in FIG. 8, where the absolute value |H| of the filter transfer function H is schematically illustrated as a function of the frequency f. The original filter transfer function H of the upsampling unit 12 is indicated by I, while the modified filter transfer function as a result of including the filter 10 in the upsampling unit 12 is indicated by II. In the example shown, the effect of integrating the filter 10 in the upsampler 12 is a narrowing of the pass-band of the filter.

This is further illustrated in the FIGS. 6 and 7. In FIG. 6, an exemplary embodiment of the downsampling unit 11 is shown in more detail. The unit 11 is shown to comprise a low-pass filter 113 and a downsampler 115. Similarly, the upsampling unit 12 is shown to comprise an interpolation unit 121 and a low-pass filter 123. The low-pass filter 123 derives its filter coefficients from a convolution unit 127 arranged for carrying out the convolution of two sets of filter coefficients. The standard coefficients sc are the coefficients normally used by the low-pass filter of an upsampling unit. The amended coefficients ac are the coefficients of the low-pass filter 10 of FIG. 3. By carrying out a convolution of the two sets of filter coefficients, the filter 123 obtained a filter characteristic which combines the characteristics of the two filters (compare FIG. 8). In this way, the advantageous features of the invention may be obtained without the expense of an additional filter (10 in FIG. 3).

An alternative embodiment of the encoding device I of the present invention is schematically illustrated in FIG. 4. The embodiment of FIG. 4 additionally contains a signal analysis (SA) unit 17 for detecting features of the picture signal, such as edges. The edge signal ES output by the signal analysis unit 17 and the residual signal RS are multiplied in a multiplier 18. This allows the residual signal RS to be amplified near edges and other features of the picture signal, typically resulting in an increased higher spatial frequencies (picture sharpness information) content.

This (relatively small) amplification of the residual signal RS near edges and other important picture features provides compensation for any higher frequencies components that may have been lost.

The embodiment of FIG. 4 also contains a combination unit (adder) 19 for combining the (attenuated) residual signal RS with an offset signal DC to adjust the DC level of the signal prior to encoding.

The signal analysis unit 17 may also be used to adjust the filter coefficient of the filter 10, as indicated by the interrupted line in FIG. 4.

A decoder for decoding the picture signal produced by the encoding device 1 of the present invention is schematically shown in FIG. 5. The decoding device of FIG. 5 comprises a first decoding unit 44 for decoding the first encoded picture signal BL, and a second decoding unit 46 for decoding the second encoded picture signal EL. An upsampling unit 41 is coupled to the first decoding unit 44. The upsampled and decoded first picture signal is subtracted from the decoded second picture signal at the subtractor 43. In the embodiment shown, an offset adjustment (offset signal DC) is carried out prior to feeding the second decoded picture signal to the subtractor 43. The signal output by the subtractor 43 is the reconstructed picture signal VS″.

An alternative embodiment of the encoding device 1 of the present invention is schematically illustrated in FIG. 9. In the embodiment of FIG. 9, the first encoder 14 is also placed outside the loop constituted by the units 11, 12 and 13. However, the first encoder 14 is followed by a decoder 15 and an upsampler 21 to produce a reconstructed picture signal VS′. In the subtractor 22, the reconstructed picture signal VS′ is subtracted from the original picture signal VS to produce an auxiliary residual signal. As in the embodiments of FIGS. 3 and 4, the main residual signal RS is produced by the subtractor 13. The main residual signal RS and the auxiliary residual signal RS′ are combined in the combination unit (adder) 25. This combined residual signal is then encoded by the second encoder 16 to produce the second encoder picture signal EL. The first encoded picture signal BL and the second encoded picture signal EL together constitute the encoded picture signal which is transmitted (for example via a cable network or the Internet) and/or stored (for example on an optical or magnetic information carrier, such as a DVD).

As can be seen from FIG. 9, the (main) residual signal RS contains no artifacts produced by the encoder 14 and is (in the embodiment shown) not produced using additional filtering (filter 10 in FIGS. 3 and 4). The auxiliary residual signal RS′ is produced in accordance with the Prior Art (compare FIG. 1) and may contain artifacts but also benefits from filtering by the encoding unit 14 and decoding unit 15. By combining the main residual signal RS and the auxiliary residual signal RS′ in the combination unit 25, the resulting residual signal is obtained which combines the advantageous features of the present invention and the prior art while mitigating the disadvantageous features.

In the embodiment of FIG. 9, multipliers 23 and 24 are provided to multiply the (main) residual signal RS and the auxiliary residual signal RS′ by weighting factor a and weighting factor b respectively. Preferably, both a and b are greater than zero and the sum of a and b is approximately equal to one (a+b≈1). In this way, the residual signal encoded by the second encoder 16 is a weighted average of the main residual picture signal RS and the auxiliary residual picture signal RS′. The exact values of the weighting factors a and b may depend on the particular application.

A further embodiment of the encoding device 1 of the prevent invention is illustrated in FIG. 10. The embodiment of FIG. 10 is similar to the embodiment of FIG. 9, and also has a first encoding unit 14 based outside of the loop constituted by the units 11, 12 and 13. In addition, an auxiliary residual picture signal RS′ is produced by the subtracting unit 22. However, in contrast to the embodiment of FIG. 9, the embodiment of FIG. 10 produces in addition to the first encoded picture signal EL a second encoded picture signal EL1 and a third encoded picture signal EL2 using the first encoding unit 14, the second encoding unit 16 and a third encoding unit 29 respectively. The second encoded picture signal EL1 is produced by encoding the (main) residual signal RS, while the third encoded picture signal EL2 is produced by encoding the difference of the original picture signal RS and the auxiliary residual picture signal RS′. This has the advantage that second encoded picture signal EL1 already provides a certain compensation for any high frequency loss and produces the enhancement layer at a relatively low bit rate. While the frequency compensation of the second encoded picture signal EL1 is an approximation, the third encoded picture signal EL2 will substantially exactly compensate any further frequency loss. The second encoding unit 16 and the third encoding unit 29 may be linked so as to avoid the duplication of encoded information. For example, any motion vectors encoded by the second encoding unit 16 need not be contained in the third encoded picture signal EL2 encoded by the third encoding unit 29. As a result, the third encoded picture signal EL2 may have a very low bit rate.

The (main) residual picture signal RS can be attenuated by an (optional) multiplier 23 to which multiplication factor C is fed. Similarly, the picture signal send to the third encoding unit 29 may be attenuated using an (optional) multiplier 28 to which multiplication factor D is fed. The factors C and D may depend on the particular application and/or the content of the picture signal.

The embodiments of FIGS. 3 and 4 may be combined with the embodiments of FIGS. 9 and 10. For example, a filter 10 may be arranged in series with the upsampling unit 12 in the embodiment of FIGS. 9 and 10. Additionally or alternatively, the filter 10 may be constituted by a series arrangement of a transform unit (for example a digital cosine transform unit), a weighting unit, an inverse weighting unit, and an inverse transform unit. Other modifications will be apparent to those skilled in the art.

The encoding device of the present invention may be used in, for example, network devices for transmitting picture information to remote units, portable consumer devices such as telephones comprising a receiver and a transmitter, and camera devices.

The present invention is based upon the insight that the bit rate of the second (“Enhancement Layer”) encoded picture signal can be reduced by removing the lossy encoder and decoder from the circuit producing the residual signal. The present invention benefits from the further insights that the quality of the picture may be substantially enhanced by including a filter in said circuit, and that a suitable bit rate reduction may be achieved by combining a residual signal produced in accordance with the present invention and a residual signal produced in accordance with the Prior Art.

It is noted that any terms used in this document should not be construed so as to limit the scope of the present invention. In particular, the words “comprise(s)” and “comprising” are not meant to exclude any elements not specifically stated. Single (circuit) elements may be substituted with multiple (circuit) elements or with their equivalents.

It will be understood by those skilled in the art that the present invention is not limited to the embodiments illustrated above and that many modifications and additions may be made without departing from the scope of the invention as defined in the appending claims.

1. An encoding device (1) for encoding a picture signal (VS), the device comprising:
downsampling means (11) for converting the original picture signal into a downsampled picture signal,
first encoding means (14) coupled to the downsampling means (11) for encoding the downsampled picture signal so as to provide a first encoded picture signal (BL),
upsampling means (12) coupled to the downsampling means (11) for converting the downsampled picture signal into an upsampled picture signal,
subtracting means (13) for producing a residual picture signal (RS) from the original picture signal and the upsampled picture signal,
second encoding means (16) for encoding the residual picture signal (RS) so as to provide a second encoded picture signal (EL),
wherein the first encoding means (14) are arranged for lossy encoding, and wherein correction means (10; 15, 21, 22) are provided for increasing the picture sharpness content of the residual picture signal (RS).

2. The device according to claim 1, wherein the correction means comprises bandwidth reduction means for reducing the bandwidth of the upsampled picture signal.

3. The device according to claim 2, wherein the bandwidth reduction means comprise filter means (10) arranged between the downsampling means (11) and the subtracting means (13), the filter means (10) preferably having a low-pass filter characteristic.

4. The device according to claim 3, wherein the filter means (10) are integral with the upsampling means (12).

5. The device according to claim 3, wherein the filter means (10) are arranged in series with the upsampling means (12).

6. The device according to claim 1, wherein the correction means comprise decoding means (15) and further upsampling means (21) for decoding and upsampling the first encoded picture signal (BL) to produce a reconstructed picture signal (VS′), further subtracting means (22) for producing the difference of the reconstructed picture signal (VS′) and the original picture signal (VS), and further adding means (25) for adding said difference to the residual signal (RS) prior to encoding.

7. The device according to claim 6, further comprising weighting means (23, 24) for weighting the picture signals output by the subtracting means (13) and the further subtracting means (22) respectively.

8. The device according to claim 6, further comprising additional encoding means (16) for encoding the residual signal output by the subtracting means so as to produce an additional encoded signal.

9. The device according to claim 1, further comprising signal analysis means (17) for analyzing the input picture signal (VS) and producing a quality signal (ES), and multiplication means (18) for multiplying the residual signal and the quality signal so as to produce a modified residual picture signal, the quality signal (ES) preferably being equal to or greater than one.

10. The device according to claim 1, further comprising combination means (19) for combining the residual picture signal or the modified residual picture signal and an offset signal (DC) so as to produce a mean value corrected residual picture signal.

11. A picture storage device comprising an encoding device (1) according to claim 1.

12. A network device for transmitting picture information to remote units, the network device comprising an encoding device (1) according to claim 1.

13. A portable consumer device comprising a receiver, a transmitter and an encoding device (1) according to claim 1.

14. A camera device comprising an encoding device (1) according to claim 1.

15. A method of encoding a picture signal (VS), the method comprising the steps of:
converting the original picture signal into a downsampled picture signal,
encoding the downsampled picture signal so as to provide a first encoded picture signal (BL),
converting the downsampled picture signal into a upsampled picture signal,
producing a residual picture signal (RS) from the original picture signal and the upsampled picture signal by subtraction,
encoding the residual picture signal (RS) so as to provide a second encoded picture signal (EL),
wherein the step of encoding the downsampled picture signal involves lossy encoding, and wherein the method further comprises the step of increasing the picture sharpness content of the residual picture signal (RS).

16. The method according to claim 15, further comprising the step of reducing the bandwidth of the upsampled picture signal.

17. The method according to claim 15, further comprising the steps of:
analyzing the input picture signal (VS) and producing a quality signal (ES), and
multiplying the residual signal and the quality signal so as to produce a modified residual picture signal,
said quality signal (ES) preferably being greater than or equal to one.

18. (canceled)

19. (canceled)

20. A computer program product for carrying out the processor executable steps of:
converting the original picture signal into a downsampled picture signal,
encoding the downsampled picture signal so as to provide a first encoded picture signal (BL),
converting the downsampled picture signal into a upsampled picture signal,
producing a residual picture signal (RS) from the original picture signal and the upsampled picture signal by subtraction,
encoding the residual picture signal (RS) so as to provide a second encoded picture signal (EL),
wherein the step of encoding the downsampled picture signal involves lossy encoding, and wherein the method further comprises the step of increasing the picture sharpness content of the residual picture signal (RS).
